(19) United States
(12) Patent Application Publication
(10) Pub. No.: US 2016/0267065 A1
(43) Pub. Date: Sep. 15, 2016

(54) Method of Governing Content Presentation of Multi-Page Electronic Documents

(71) Applicant: Leonard L. Drey, St. Louis, MO (US)

(72) Inventor: Leonard L. Drey, St. Louis, MO (US)

(21) Appl. No.: 14/524,694

(22) Filed: Oct. 27, 2014

Related U.S. Application Data
(60) Provisional application No. 61/895,654, filed on Oct. 25, 2013.
(60) Provisional application No. 61/904,252, filed on Nov. 14, 2013.
(60) Provisional application No. 61/908,383, filed on Nov. 25, 2013.

(51) Int. Cl. G06F 17/22; G06F 17/24; G06Q 30/04; G06F 17/30

(52) U.S. Cl. CPC G06F 17/2288; G06F 17/30011; G06F 17/241; G06Q 30/04

(57) ABSTRACT

A method of governing content presentation includes creating a document file including content presented to a user in sequential units on a display device. A current version of the consent is presented in which fewer than all of the units are viewable. After the user performs a predetermined action, a subsequent version of the content is presented. Unviewable units of content in the current version are viewable in the subsequent version. Alternatively, a delimiter is inserted in the document file and after passing the delimiter while viewing content, the subsequent version is presented. An integrated device includes a microprocessor device, an electronic display device, and a storage medium that includes intransient instructions in a variable computer-readable document file that can be implemented by the microprocessor device to cause a document to be displayed to a user on the electronic display device according to instructions included in a program file.

### CROSS-REFERENCE TO RELATED APPLICATIONS

This is related to, and claims priority from, U.S. Provisional Application for Patent No. 61/895,654, which was filed on Oct. 25, 2013; U.S. Provisional Application for Patent No. 61/904,252, which was filed on Nov. 14, 2013; and U.S. Provisional Application for Patent No. 61/908,383, which was filed on Nov. 25, 2013; the disclosures of ail of which are incorporated herein.

### FIELD OF THE INVENTION

The invention relates to methods of presenting content to a viewer, for example, on a computer display or a dedicated electronic display device. In particular, the invention relates to a means of control over the timing of the presentation of multiple pages of content.

### BACKGROUND OF THE INVENTION

Content, and text in particular, is normally presented in a static fashion. That is, when a reader reads text and other content in hard-copy form, text and images do not change, and subtle nuances in the meaning of what the author wishes to convey must be expressed through the careful choice of words and the linear, static emplacement of words and images. If readers want to understand better, they can read the identical content twice. Content provided to a viewer on a computer has the potential to overcome this constraint, but this capability is underutilized A need exists to enhance the capability of electronic media so that dynamic content can be provided in ways that will transcend the limitations of static, linear expression.

The concept that there could be, inside a published work, any commenting “hidden pages” between original pages of text, viewable by the reader only after he or she had read some pages further into the document, is a notion that would have seemed so unsound in the old world of paper publishing that probably then it had never been considered—despite the usefulness of the approach.

Recently the capacity for Web-based electronic books and articles to be published in various formats has been proffered by certain electronic publishers. However, a limitation shared by ail of these pertains to the publisher's inability to limit dissemination of a document after the sale. Electronic books published by these methods can costlessly be multiplied by buyers, quite easily—even to the extent that such publishers do not caution against the practice.

In a similar way problems are faced by especially corporations and governmental organisations, stemming from the evident. Impossibility of preventing confidential documents—even millions at a time—from being surreptitiously copied to small electronic storage devices by individual who have had access to these legally at the time, but now wish to disseminate them illegitimately. It would be optimal if such documents, once they had been circulated to members of a carefully selected “core group” reading list, for instance could be copied only onto one electronic storage device, and then locked onto that device permanently.

And similarly, there may be times when an author or publisher would wish it if certain readers—ignorant but vain readers, let us argue—who have neither the training nor the temperament to comprehend the work at question, yet who would assume that they did, while reading—from being able to access the document easily.

Further, sometimes a publisher or an author might find it ideal if a document, although being made available online, could be made non-searchable by conventional search engines.

At present no means has existed to accomplish any of these.

Till now.

### BRIEF SUMMARY OF THE INVENTION

Through using the present invention, to a large extent an author can prevent potential readers whom he or she would want not to read a work from reading it. As a non-limiting example, if an author has written something that he feels is excessively personal or that he feels the average reader—because of a lack of training or lack of exposure to relevant life experiences—could not understand, no matter what he or she would think after having read it, that author can limit dissemination by preparing an “aeceptables” list of email addresses, against which requests for the work would be matched by the publisher's server before these were fulfilled.

Through use of the invention, authors will not be able to block everyone whom they did not wish to read a work from getting their hands on it, of course; copies could be borrowed or stolen. But in the author's eyes “the wrong sort of people” will at least not be able to go to the store and buy a copy, click on a link, or have the work drop into their inbox as an unsolicited attachment.

Where the invention is in use as a means of limiting the dissemination of sensitive materials, as for instance in corporations or government agencies, a disgruntled or disturbed, or merely venal employee will be blocked from easily copying up to millions of confidential and/or embarrassing documents to a “Manning device,” meaning a simple USB memory stick, and walking away from the office with this in his pocket.

In the same context, it should be noted that for now, documents published under this invention are unsearchable by search engines, since the contents are contained within strings.

According to an aspect of the invention, a method of governing content presentation includes creating a document file. The document file is a variable computer-readable file that includes content, which is presented to a user in discrete units in sequence on an electronic display device. A current version of the content is presented in which fewer than all of the units of the content are viewable by the user. At least some units of unviewable content are interspersed between units of viewable content. The user performs a predetermined action. In response to performance of the predetermined action, a subsequent version of the content is presented, such that at least some of the unviewable units of content in the current version of the content are viewable in the subsequent version of the content.

When the predetermined action or another predetermined action is performed by the user, presentation of the content can be returned to a previous unit of content, which can be a unit of content that was unviewable in the current version.

In some embodiments, the subsequent version of the content is not presented on performance of the predetermined action unless a predetermined number of units of content has been viewed by the user prior to performance of the predetermined action.

A monetary charge can be associated with a performance of the predetermined action. A total monetary charge can be increased each time the predetermined action is performed. The user can be notified each time the total monetary charge is increased. Indicia can be provided to the user showing the total monetary charge.

The predetermined action can be, for example, movement of an action key. The action key can be an element of an input device in communication with a microprocessor device that is in communication with the electronic display device.

At least some of the unviewable content can be textual content. The unviewable content can include annotation content.

The electronic display device can define a size of a unit of content

The electronic display device can be a dedicated content reader.

Preferably, at least for the author, creating a document file does not include writing programming code.

The content can also include at least one data tag. The at least one object tag can include formatting tags, hyperlink tags, image source tags, sound source tags, video source tags, table tags, form tags, frame tags, style tags, div tags, class tags, embed tags, object elements, JavaScript, and/or Java applets.

Presenting the content can include reading the document file using a network interface. For example, the network interface can be a Web browser.

The document file can be a plaintext file, an HTML file, or an XHTML file, and can incorporate Javascript. The unviewable content can include, for example, advertising content and annotation content.

The predetermined action can be providing a correct response to a query.

The document file can include at least a textual portion, and the method can also include inserting at least one delimiter at a selected position of the textual portion of the document file, defining delimited content, and tracking predetermined events and/or actions that occur while the user views units of content. The selected position can be occupied by a particular character combination including the at least one delimiter. When the at least one delimiter is reached as the user views units of content, any of several consequences can result. For example, advancement of content can be stopped until further action is taken by the user; presentation of content can be paused for a selectable, discrete number of time units; presentation of the document file can be automatically redirected to a different location in the document file; and/or any other action can occur.

Tracking predetermined events and/or actions that occur while the user views units of content can include tracking a number of the delimiters passed by the user while viewing units of content, and/or tracking a number of units of content passed by the user while viewing. A monetary charge can be associated with the tracked number of delimiters passed by the user and/or the tracked number of units of content passed by the user while viewing. Preferably, the delimiters are present in units of viewable content of the current version of the content. A total monetary charge can be increased each time a delimiter is passed by the user and/or each time the number of units of content is passed while viewing. The user can be notified each time the total monetary charge is increased, and an indication can be provided to the user showing the total monetary charge. The unit of content can be, for example, a string.

A browser, a jump drive operating system, and/or the document file can be modified to render the modified document file unable to be modified. A browser, a jump drive operating system, and/or the document file can be modified to render the modified document file unable to be stored except on the modified jump drive. The document file can be modified so that it includes a designated extension. An operating executable file can be stored on a jump drive associated with the modified jump drive operating system. A filename that includes a designated file code is assigned to the modified document file, and a designated browser code is assigned to the modified browser. The modified document file is stored on the jump drive. An operating program associated with the operating executable file is used to determine if the file code is valid, based on a predetermined criterion. The operating program associated with the operating executable file is used to determine if the browser code is valid, based on a predetermined criterion. The modified document file is opened in a browser window by the modified browser only if the file code and the browser code are both determined to be valid. The modified document file is not opened if one or both of the file code and the browser code is determined not to be valid. The container ID can be registered with a publisher, and storage of the modified document file on any jump drive having an unregistered container ID can be prevented.

According to another aspect of the invention, a method of governing content presentation includes creating a document file. The document file is a variable computer-readable file that includes content. The content is presented to a user in discrete units in sequence on a display device. A current version of the content is presented, in which fewer than all of the units of the contents are viewable by the user. At least some units of unviewable content are interspersed between units of viewable content. At least one delimiter is inserted at a selected position of the document file. Units of content are viewed sequentially by the user. In response to passing the selected position by the user while viewing content, a subsequent version of the content is presented in which at least some of the unviewable units of content in the current version of the content are viewable in the subsequent version of the content.

According to another aspect of the invention, an integrated device includes a storage medium, a microprocessor device, and an electronic display device. The storage medium includes intransient instructions in a variable computer-readable document file that can be implemented by the microprocessor device to cause a document to be displayed to a user on the electronic display device according to instructions included in a program file. The instructions in the document file include allowing an author to create variable computer-readable content as a portion of the document file. The content is presentable on the electronic display device in sequential, discrete units. The instructions also include presenting on the electronic display device a current version of the content, in which fewer than all of the units of the contents are viewable by the user. At least some units of unviewable content are interspersed between units of viewable content. The instructions also include recognizing when a predetermined action is performed by the user, and in response to recognition of performance of the predetermined action, presenting a subsequent version of the content. At least some of the unviewable units of content in the current version of the content are viewable in the subsequent version of the content. The instructions included in the program file are a computer-readable instructions that are largely unvarying and include previously programmed computer code allowing the document file to be executed.

Because the unit of textual representation in a document file is the string, documents published using this method will be unsearchable through contemporary search engines—none of which has a search algorithm that allows searches into strings.

### BRIEF DESCRIPTION OF THE DRAWINGS

FIG. 1 is a flow diagram that shows an exemplary general process of the invention.

FIG. 2 is a flow diagram that shows a particular exemplary aspect of the authoring and display processes of the invention.

FIG. 3 is a flow diagram that shows a particular exemplary aspect of the authoring and display processes of the invention.

FIG. 4 is a flow diagram that shows a particular exemplary aspect of the authoring and display processes of the invention.

FIG. 5 is a flow diagram that shows a particular exemplary aspect of the authoring process of the invention.

FIG. 6 is a block diagram of an exemplary integrated device according to the invention.

### DETAILED DESCRIPTION OF THE INVENTION

The present invention provides a way for presenting a document consisting of text characters and/or other content to a viewer, such as a computer user, in multiple versions which can be temporally sequenced according to the depression of one or more predetermined control or action keys, as specified by the author of the document being viewed. For example, according to the invention, a document can include words, letters, numerals, symbols, blocks of color, digital photographs, graphical images, movies, sound, any other visual and/or audio binary file, forms or interactive forms, structured data, markup language data, links, and Web pages, which can be presented on a viewer's display sequentially as two or more versions, both of these or all of these controlled by the reader using an action key or keys, the second and/or later versions only being brought before the viewer once he or she has struck the pertinent action key, or according to an alternate construction of the invention's program file, automatically being brought before the viewer once a certain point or points in a document file, as determined by the document's author, has or have been reached by the viewer, such points being, for example, the end of the last page and string of the first version of the document.

For example, versions of the document can differ by the presence of “interleaves” disposed in a second and any subsequent versions of the document as presented to the user, each version of the document file being sequentially read by a microprocessor device according to instructions contained in the program file and subordinately, the text file. If for example there are two versions of a document, the first version will bypass all of the interleaves and only the second version present the interleaves in their proper order. In other words, the electronic publication will have multiple interleaves hidden between designated pages or sections of the document as originally presented to a viewer. These interleaves normally will be hidden from the reader so by the document's author's design, the viewer will not see them the first time reading through the book. Then, after a predetermined action, such as actuation of a predetermined key by the viewer, the second version of the content is presented to the viewer. The second version includes interleaved content that was not available to the viewer -when accessing the first version (unless incorrectly, the reader engages in the predetermined action to summon the interleaves other than at the point or points intended by the author). Preferably, the viewer is automatically returned to the beginning of the content when accessing the second version, although this is not necessarily the case. If the author wishes to, he or she may create at the beginning of the second version a “hidden preface,” an indefinitely large number of pages and strings that will be presented to the viewer only once he or she accesses the second version, the hidden preface in the second version therefore being accessed before the reader reaches for a second time, the first page of the first version. In a like manner, if the author wishes to, he or she may create at the end of the second version a “hidden afterword,” an indefinitely large number of strings and pages that will be presented to the viewer only once the second version has been accessed by the viewer, and after the end of the last page and string of the second version has been reached by the viewer.

Thus, according to the invention, the author or a commentator can provide interleaved material that complements or comments on the original material For example, the interleaved content can include notes by the author of the original work, scholarly comments and interpretations by others, and historical and geographical facts related to passages in the content provided. Material in interleaves may be written by the author, editors, or later commentators, and interleaved material may qualify or advance the initially presented material.

Educational material other non-fiction works, or essay “interleaved” publications may be pitched at two levels; on the first level, to the reader who is somewhat new to the information and to the conclusions that the author wishes to convey, and on the second level, to the same individual who is now familiar with these in outline and is ready to be exposed to and to take in, through a non-linear commentary on the simpler work, more advanced ideas that are more nuanced and more emphatic and focused than is possible in conventional, that is to say, linear publishing. Via use of the invention, readers will be provided with a more nuanced and complex analysis of ideas and facts, or a more “qualified” and tentative presentation of ideas and facts, or a more advanced presentation of ideas and facts, than they could have been, before. Furthermore, works of fiction,

Including adult, children's, and juvenile fiction, as well as comics and graphic novels, can be published according to the invention.

If an author wishes to write a preface that initially cannot be seen by the viewer, he or she may do so by interspersing a certain number of blank screens that will be passed over as the program is automatically progressing to the first visible page; the author may construct an “invisible preface” by alternating blank pages with a coordinate number of interleaves. A similar thing may be done to create an “invisible afterword.” in both cases, the program will proceed automatically and rapidly in succession through these blank screens because the author will not have inserted a “pause delimiter” or a “stop delimiter” within the strings coding for each of these blank screens. The initially invisible preface or the initially invisible afterword can be of any number of pages in length, according to the author's preference.

From a commercial standpoint, the invention provides advantageous ways to generate revenue. For example, a publisher of the content can make the first version of the content free of advertising, but can include paid advertisements in some or all of the interleaved content revealed in the second version. Alternatively, the publisher can provide a free, incomplete, first summary version of a publication, and a second, complete version that is available only on payment of a fee. To access the second version, readers can be required to pay at a constant rate or at an often-varying or a constantly varying page-rate, as determined by the publisher. A publisher can offer readers the option of previewing a predetermined traction of the content without charge to determine their level of interest, before they decide to begin paying to access further parts of the complete publication.

A single action key to invoke the second version of a document will be referred to herein, but the invention is not contemplated necessarily to be limited to a single action key, and more than one key can be designated as action keys if desired. More than two versions of a document are possible; thus, more than one set of interleaves are possible. If more than one set of interleaves are authored, the same action key or more than one action key can be used to summon the different interleaved versions. The action key can be, for example, the <LEFT-ARROW> key on a standard computer keyboard. Specialized keys on a dedicated device can be provided to implement functionality.

Thus, according to a particular embodiment of the invention, series of versions of a document can be presented sequentially to the viewer, wherein the sequencing of the versions is predetermined by the author at the time of authoring of the text, and the viewing of a second or subsequent sequence can be invoked by the viewer according to the depression of an action key. For example, a document, such as a book in electronic form, can be presented to a viewer. This document can be stored locally, such as in memory in a computer or a portable electronic device on which the document is viewed. Alternatively, the document can be stored remotely, such as on a remote computer, and streamed to or otherwise provided to a computer or other electronic device via a network or peer-to-peer connection.

Multiple action keys can be utilized, such that pressing any of these will return a reader to a different “re-starting point” in the original document. Such keys preferably are sequential number keys, letter keys, or combinations of keys, but may be any keys designated by the author or publisher. A second “back function” can be used to allow the reader to progress backward through a document one page at a time, for example to permit an author to expand on the meaning of a new term or concept that appears in the original text, now in the preceding interleaf. Where this back function is operable, the program file can be modified to limit the number of back keystrokes permissible at one time, in order to prevent reader confusion and/or to prevent fee delimiters from being bypassed. For the same reasons, the program file can be modified to prevent back-to-the-beginning or back-to-another-point keys from being activated before a reader reaches a predetermined point in the document.

If an author intends to utilize both types of interleaves in the same document according to the invention, that is, interleaves of the “go back to a certain re-starting page” type, and interleaves of the “go-back-one-string-at-a-time” type, he or she can modify the operating program's “skip” number, the number of interleaf strings that are automatically skipped over per “forward” action key strike by a user during a first reading of a document, so that this number will be the number of interleaf pages found between pairs of pages of original text, plus one. Where such a modification to this number is made, readers who have been advancing through interleaves of the first type, at the author's discretion will encounter at least one blank screen before reaching interleaves of the second type, when both types of interleaves are present between successive pages of the original text. In such a “mixed set” of interleaves, the first subset of interleaves will refer to the previous page of original text, whereas the second subset will refer to the following page of original text.

The availability of interleaf pages at a point in a document may be made known to users through placement of a “flag” in the original text. As necessary, this flag will designate the specific key to be pressed.

The original version of the document, in this example a book, can be provided to the viewer, either for free or on payment of a fee or purchase price. When the viewer has finished reading the book, or at another time of the viewer's choosing, the viewer can, by going back to the beginning of the book, or by going back to another point in the original version of the book that has been chosen by the author as a re-starting point—or by-otherwise indicating that he or she wants to view the-second version of the book—view the second version of the book; alternatively, the viewer can be brought back automatically to the beginning of the book or to any other re-starting point when he or she has reached a certain point or points in the original version of the book as determined by the author. At that time, the second version of the book, including the previously-missing “interleaves,” will be presented to the viewer. The viewer may have to provide payment to view the second version. The interleaves provided in this second version can include, for example, formatted and in-a-different-background-color “boxed notations” resembling footnotes, which need not be located at the bottom of a page, yet may be disposed in any location on a page, to provide insight into different aspects of the book. These aspects of the book may not have been able to be presented by the author in the first version for reasons of comprehensibility. The notations can include, for example, scholarly insights, references, illustrations, and links to related reading material that was written by the same or other authors. The ability for the viewer to highlight or add his or her own notations to the original text or interleaved text can also be enabled by the reader through summoning the source code of a document, and then altering it by adding his or her own “reader's notes.” Such notes may comprise passages added by the reader at the end of pre-existing paragraphs or screens of text, or may be made to appear anywhere on the screen in colored “boxes,” formatted by the author using the Cascading Style Sheets (CSS) function of HTML, for example. Paid advertisements that must be read or watched by the reader before proceeding to further interleaves, or past “stop delimiters” to further notations within a single interleaf, can also be included. Interactive content, such as questions asked of the viewer, to which the viewer may or must respond before proceeding further in an interleaved version, can also be included. In this case, subsequent material or a complete, subsequent version consisting of additional interleaves can be provided if the viewer has correctly answered questions that have been written by the author. Alternatively, additional interleaves can be provided to a viewer regardless of the correctness of the reader's answers, yet the price that the reader pays per page to generate further interleaves can be incremented or decremented according to a predetermined mathematical formula, depending on the acecurateness of the reader's answers.

According to an alternative embodiment of the invention, the first version of the document is a concise and abbreviated version, or an abridged version, which becomes complete in the second version or in another subsequent version. This allows the publisher to give a prospective purchaser a preview of a book or other content at no or little cost in the first version, and the complete document in a subsequent version, on payment of a fee and/or acceptance of advertisements. The content that completes the document, and any optional advertising, is present in the interleaves that are only accessible to the viewer hi the second version. Interleaved pages available only in the second version may greatly outnumber those available in the first version, so that only a spare outline of the document can be previewed.

To implement the method of the invention, test is written by an author/programmer so as to be read by a reader's computer, or other microprocessor-driven device, as computer code. This code can be, for example, similar to or no different from ordinary HTML code, yet the method of the invention provides several advantages. The code includes delimiters that the author can use when writing/coding that will stop or delay presentation of content to the viewer, charge viewers a variable amount as that point in the document is passed, or return to the beginning of the document. These delimiters can be combined. So, for example, the document can be returned to the beginning after passing an end-of-document delimiter, at which point, once progression of the document has stopped, the viewer can be prompted for payment as a condition to view the subsequent version of the document, including inteleaves.

In a preferred embodiment, the text or other content is authored such that text, or the ordinary language of HTML or XHTML or another compatible language for the Web, is augmented with new delimiters. The text is coded by the author in “strings” that include the delimiters, wherein each string presents a new screen of text. For example, a string can begin with

LABEL(“ . . .

and end with

. . . )”,

to identify delimited text, where “LABEL” is a label chosen by the author to designate the delimiter. A first delimiter allows the author to allow the viewer to advance presentation of the content, while a second delimiter allows the author to delay presentation of the document a preset number of tenths of a second, and a third delimiter allows the author to return presentation of the document to the beginning or some other point in the document, irrespective of any action by the reader. Although three such delimiters are described herein, additional or different delimiters can be used to provide similar or different functions, as will be apparent to one of skill in the art. According to the method of the invention, all formatting features of HTML can be used. Retaining the broad feature set capability of HTML provides great ad vantages to the author.

Annotations can also be made to appear or go away at the stroke of an action key. For example, these notes can appear in indented and highlighted boxes, or in any other format of the author's choosing, once the interleaves are enabled. Highlighting or other emphasis of text can also arise, timed to appear automatically according to the author's specification or on depression of the action key by the viewer.

HTML documents can be made to appear as advertisements that appear on the viewer's screen, one by one, in a timed sequence or at the control of the viewer, once interleaves are enabled in a second or subsequent version. For boxes or pages to appear in an automatic timed sequence within or as a complete individual string that makes up a non-interleaf page, a delay delimiter can be inserted. For example, ̂̂25̂ or a similar delimiter is inserted, where “̂” is a space, and where “space-space-number-space” is the incremental delay delimiter denoting the number of incremental delay units selected by the author/programmer, here measured in tenths of a second. Likewise, in non-interleaf pages “space-space-vertical pipe-space” (̂̂|̂) can be used as the “stop until the action key is depressed” delimiter, so that pages can change at the control of the viewer. An “automatic blank screen.” string, for example,

LABEL(“ ”);

can be made to occur between non-interleaf strings, to generate a momentarily blank screen between screens of text. At the same time, insertion of such a blank screen will cause the first element of the following screen to be placed correctly in terms of its vertical location on the screen, rather than being placing arbitrarily according to the location of the elements that were last read in the prior screen.

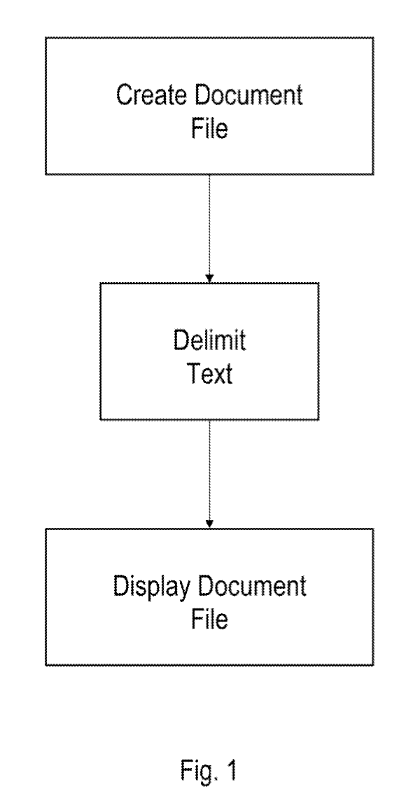

An exemplary general process of the invention is shown in FIG. 1. As shown, the author creates a document file by authoring content that preferably includes text. Predetermined portions of the text are delimited in order to define delimited content. The document file is then read by a microprocessor device and displayed to a viewer, and the delimited content is displayed differently than other portions of the content of the document file according to the nature of the delimiters chosen by the author/programmer. The coding of the delimiters can be made transparent to the author, because this coding is concealed in the document file within the program file, separately from the text file and in a way that the author is not expected to modify, or need to modify. Therefore, computer programming skills are not needed at the time of authoring or formatting of an article or book. For example, an author may apply any delimiters of his or her choosing through utilizing the same word processing program he or she uses to author ordinary static-text documents. Regardless of location, delimiters will “drop out” in the sense that although they will have meaning to the microprocessor running the conjoint document and program files, the viewer will never see the characters or the spaces of the delimiters on his or her screen.

The document file need not only include text, and instead can be a multimedia file including still and moving images and sound as content, any portion of which can be delimited. Further, HTML files and XHTML files can be document files that are authored according to the invention, and any section of such a document can be delimited for controlled presentation to a viewer.

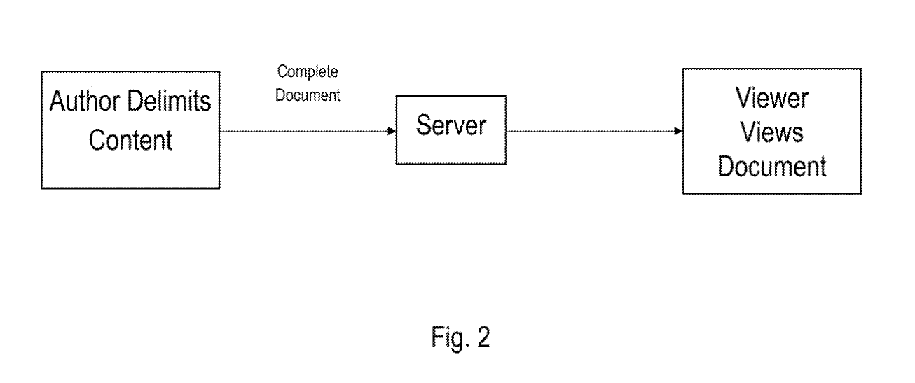

As shown in FIG. 2, as part of the authoring process, the author defines delimited content in the document file as the text file component of the document file is first authored, or later, in a separate delimiting action. The viewer will display the document on a microprocessor device such as a computer or dedicated document reader, which will identify the delimited content and present it to the viewer as specified by the author. If the computer or other viewing device is connected to a network, a conjoint text and program file can be stored on a server or in a location at which it can be accessed by a server, and a network interface program can be used to view the document file. Or alternately, the text file and the program file can be stored in separate locations, particularly if the program file does not need to be altered to run a certain text file. For example, a Web browser running on a notebook computer with a wireless internet connection can be used to view the document file through reference to the program file, where the conjoined text and program files can be accessed via the reader's typing in the Web address of the conjoined document (the text file as this is embedded within the program file) in a browser task bar.

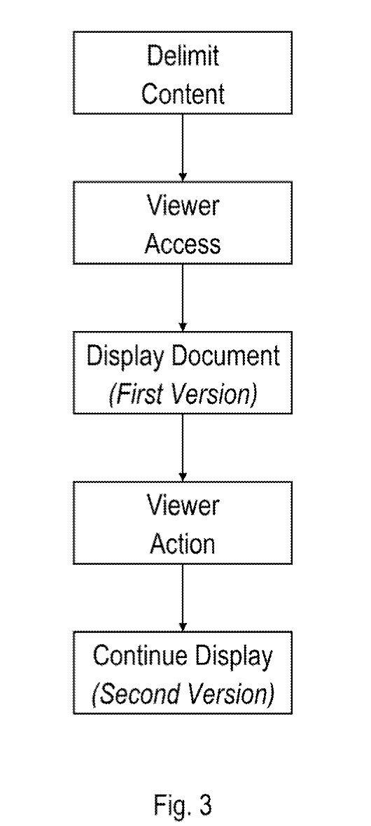

As shown in FIG. 3, the authoring process can include delimiting the content such that further action is required by the viewer to access the second version of the document file. As previously discussed, this action can include the use of an action key. The viewer will be able to display a portion of the complete document file, but subsequent viewing of delimited content will require additional action as specified by the author.

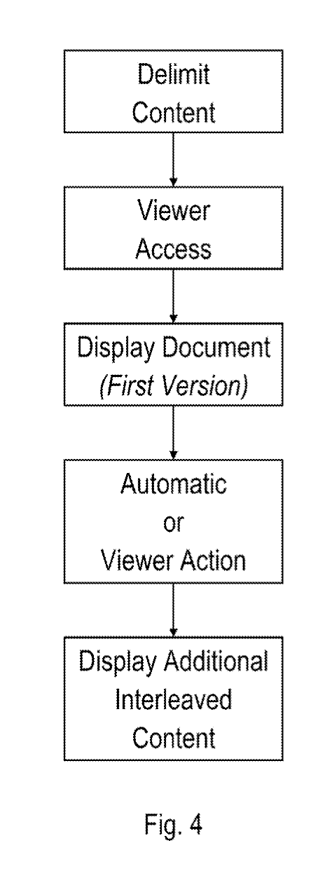

As shown in FIG. 4, the authoring process can include delimiting content for placement of interleaved content, which interleaved content can be displayed after viewer action. For example, interleaved pages including annotation content on interleaved pages can be presented in a second version of a document after a viewer has read the first version, according to the designs of the author as he or she created the document file. This second version will be presented only after the viewer has pressed a “back-to-the-beginning” action key to return to the beginning of the document and view the second version of the document, or it will be presented to the viewer automatically, when the viewer passes a point or points in the document as determined by the author, these designated by author using a certain delimiter, for example a “̂̂∥̂” delimiter. The second version will comprise the first version of the document, but now between its pages there will be the interleaves including annotation material as designated by the author.

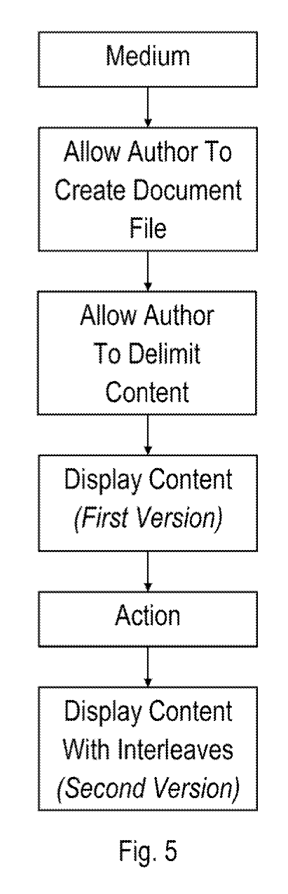

Thus, the authoring process includes creating content and delimiting it so that presentation of interleaved content is controlled either automatically or by the viewer through activating an action key. The capability to author a document in this manner can be provided by any word processing program. This document, now in the sense of a “document file,” can be stored on a medium such as a portable memory device or a hard drive internal to a computer, or as instructions resident temporarily in RAM. The stored instructions can be implemented by a microprocessor device through reference to an unchanging or modestly modifiable program file, which will be combined with the document file or will be stored separately and cause a document to be displayed on an electronic device, as generally shown in FIG. 5. Although in the exemplary implementation of the invention, the text file will be written in ordinary HTML or XHTML code, the program file preferably will be written in JavaScript. Multi-page documents including interleaved versions will be presented as single web pages in an ordinary web browser. Text file code can be accessible to viewers, allowing them to modify their copy of the text file in the sense of adding their comments to their own copies.

Text for presentation according to the invention can be created by modifying previously-authored plain-text documents. Such plain-text documents are divided into strings, each string representing a single page or other predefined unit. Strings are marked up in a markup language, such as HTML, and delimiters are added. The resulting text file is inserted into the program, to be acted on by a program file that is also present in the document file.

An author can make simple modifications to the program file to adapt it to a particular text file. For example, he or she can increase the number of specifically targeted “back” keys and their targets' location, or change the number of strings skipped over when the original text is read. “Back” keys may also redirect the reading frame ahead, the name notwithstanding.

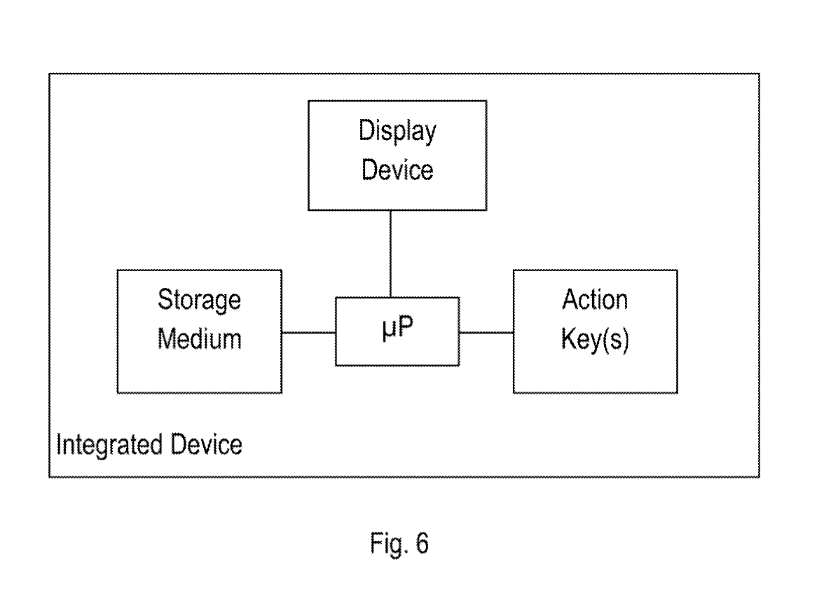

It is also contemplated that the invention can be embodied as an integrated device that includes the storage medium described above, as well as a microprocessor device and an electronic display device, as shown in FIG. 6. The integrated device can include an action key in communication with the microprocessor device for initiating viewer action.

Although the invention has been described to this point in terms of viewing versions of a complete document, it is contemplated that a document can be divided, such as into chapters, and that the chapters or other components can be serialized individually, in order or otherwise, each component having one or more interleaved versions that can be presented to a viewer. For example, a sequence of strings, each representing an individual page in the document, can be written in such a way as to cause a table of contents to appear after a number of strings has been viewed, which table of contents will be hyperlinked so the process can resume in the selected document With or without hyperlinks, an ensuing document can be indefinitely long and can resemble a magazine, newspaper, or book, with any number of pages and any number of articles or chapters. “Chapter jump forward,” “chapter jump back,” and “jump screen behind” features, or other non-sequential access features, can also be provided through modification of the program file. Tables of contents can comprise simple hyperlinked lists, or they can be geometrically more complex shapes, including graphics, digital photographs, and text, created, for example, using HTML's “table” or Cascading Style Sheets “DIV” functions, preferably hyperlinked. “Advertisement boxes,” possibly hyperlinked to Web pages and possibly authored according to the method of this invention, can also appear on table of contents pages, or anywhere else in the document, including between pages of otherwise-continuous narrative text.

Other embodiments of the invention can relate to the tracking of content consumed by the viewer, and to charging a fee for content consumed by a viewer. For example, when an action key is depressed by the viewer as described above or when a “page back” key is pressed, an incremental charge can be incurred, to be debited from a pre-paid account or to be charged at a later time. This charge can be incurred in response to every depression of the action key, forward or backward, or per a predetermined multiple number of depressions, or according to any scheme devised by the author and implemented as a revision in the program file. If desired, charges can increment as the viewer moves forward through the document, irrespective of action-key depression, depending for example on the reader's passing the end of strings, or passing “delay” delimiters. Thus, interleaved pages can be presented to a viewer individually, with the understanding that a set fee or a variable fee, as determined by another delimiter, will be paid for each accessed interleaved page. The invention can be used to track usage and charge the viewer accordingly.

Alternatively, a special delimiter can be added to the textual content of non-interleaf pages such that the act of “passing” the delimiter by the viewer automatically results in an incremental charge to the viewer. Such a delimiter might be, for example, “space-space-vertical pipe-number-space,” where the number can be varied by the author and indicates the fee assessed for passing the delimiter in tenths of a dollar.

These or similar methods can permit an author to monitor any key depressions and/or forward or backward progression through content, and consumption of content in selectable portions, such as words, paragraphs, pages, etc. This consumption can be tracked and counted, and the viewer can be charged correspondingly. Alternatively, the resulting data can be used by an author, editor, or publisher to understand reader interests and habits better. Likewise, it can be used by the publisher of a periodical published under this method to determine staff writers' compensation, and to assist the publisher in fulfilling other functions specific to the role of publisher.

The content as seen by the viewer can include an indication of his or her current incurred charges, preferably at the reader's option. For example, a small window or other display region can be provided, in which is shown the total current charges incurred by the viewer. If a viewer is required to answer test questions as he or she proceeds through a document, his or her current score can appear in this window or other display. A resulting mathematical factor may be utilized by an author to determine a factor by which the viewer's per-delimiter fee or per-page fees will be multiplied, and this factor can also be shown. This display region can also inform the viewer when a charge delimiter has been reached or passed. Likewise, a document can be made to provide an indication, such as an audible indication, to the viewer whenever the total amount has been incremented, or will be incremented upon an action key's being pressed.

Off-line viewing of documents can also be permitted, with content consumption and associated charges determined only when the viewer next logs on to the content-provider's Web site. While off-line, through attending to their fee total, viewers can limit their consumption to remain within a preferred tolerance.

Thus, according to the invention, the author of a document can control the manner in which it is displayed to a reader. For example, an incomplete version, followed by a more complete version, followed by still more complete versions, some or all of which might be annotated, can be provided to the viewer in sequence, through the use of interleaved content. Advertisements can be included as at least a portion of the interleaved content of any version. Also, fee delimiters can be included within the interleaved pages and ordinary pages of a document in order that a publisher, author or editor, or later commenter can levy appropriate fees of viewers commensurate with their “intake” of the document. To repeat and now stress, this element of the invention allows viewers to be charged on a “by-consumption basis” not merely for use of interleaves but also for use of ordinary pages.

The present invention includes the method as described above. Within the scope of the invention, the method can be implemented as a computer program that can run on a computer or any device having a processor, including a dedicated reading device. The program can be loaded onto the computer directly, or can be implemented over the internet or any other network. The invention can also be embodied as a non-transient storage medium on which are stored instructions that can be interpreted by a processor to cause a computer or other device to perform actions according to the described method, as described above.

The invention can also be embodied as a computer or other device on which the method is performed. For example, a general-purpose computer, including a processor, memory, one or more input devices, and a display of some sort, set up to view test as described herein, or set up on a network or as a stand-alone device and receiving documents authored according to the invention, is contemplated as falling within the scope of the invention. A special-purpose device dedicated to reading documents authored according to the invention is likewise contemplated. For example, document files can be loaded onto and stored on a portable memory medium that can be attached to and read by such a special-purpose device, or document files can be downloaded onto such device via a network or directly from another computer or other electronic device. Such a special-purpose “reader” will preferably be portable and will present documents to a viewer. Such a device can be functionally simple, including a display, action keys, and a pointing device that can move a cursor to navigate the table of contents of a document being read. For example, a portable console having a suitable display can be provided with a touchpad pointing device and buttons, advantageously located for manipulation by a reader. The buttons can be used as the action, key to move a document forward, as the action key to move a document backwards a page at a time, and as the action key to return the viewer to the beginning of a document, from which he can begin to view interleaved versions. In combination with the touch pad, action keys can be used to navigate a table of contents. For example, a portable console having a suitable display can be provided on its rear surface with a touchpad pointing device and a single button, advantageously located for manipulation use by the reader as the action key. Lateral movements made with the index finger of one hand on the touchpad device can be translated by the device into vertical movements through the table of contents.

It is also contemplated that more than one action key can be specified, or provided on a dedicated device. For example, the left-arrow key on a typical keyboard can be designated to be used by the viewer to drive the presentation backwards a page at a time. For example, using this key, a bit of content can be viewed mote than once. Likewise, the right-arrow key on a typical keyboard, through being pressed by a viewer continuously, can be designated to be used by the viewer to return the document to the point where the viewer had left off regardless of bow many times the left-arrow key and/or the Enter (action) key had been used in the intervening time. Up-arrow and down-arrow keys can be used by the reader to navigate a page longer than a single screen. If a special-purpose device is created dedicated to reading documents authored according to the invention, right-arrow, up-arrow, and down-arrow keys may be added to the rear surface for use by the reader. Alternately, all four keys may be placed on the front of the device, or the screen itself may be utilized as a sensitive touch device, preferably without visual designation of the specific areas of sensitivity.

Thus, it is apparent that the invention provides a number of advantages over static text as it is presented in printed books and magazines and in “eBooks.”

Furthermore, whereas eBooks and multipage commercial word-processor documents such as those generated in Microsoft Word, Microsoft PowerPoint, and Adobe Acrobat, necessitate transmission by fast-speed internet connections because of their large file sizes, moderately long articles authored according to this method, if they employ only text, can have file-sizes of only a few tens of kilobytes, allowing even long-articles and books to be downloaded quickly, regardless of whether users are restricted to using a “pre-modern” internet connection, such as a slow dial-up connection.

The following is a non-limiting example of content provided to a viewer according to the invention. A document is provided to a user as a Javascript and HTML file, preferably as an email attachment or as a direct download either to a portable device such as a laptop, smartphone, or tablet computer, or to a non-portable electronic device such as a desktop computer. Once the file is opened in a Web browser, it is presented to the viewer as a series of pages, which each can contain any combination of text and media content. Each page can be sized to be viewed on a single screen of the viewer's device, or can be scrollable. If according to author's wishes, during presentation of a document the current page does not automatically progress to the next page, then when the viewer has finished consuming the content on a current page, he or she actuates a predetermined key to move on to the next page. For example, pressing the right-arrow key on a viewer's computer keyboard or dedicated reader keypad can advance the content to the next page. Of course, touching the right-arrow zone on a touchscreen of a touchscreen-enabled device would have the same effect.

According to the invention, it is possible that the next page will deviate only infinitesimally from the prior one, for example only in the coloring or font style, holding, italicization, underlining, or highlighting of a single word, or can deviate more markedly from it, through, for example, the addition of a commenting text box or boxes; or the two pages can be entirely different from each another, or can be no different from one another whatsoever.

Once the viewer has consumed all content in the current version of the document, or has consumed ail desired content up to a certain point in the document, or again if the viewer simply decides at some point, for arbitrary or non-arbitrary reasons, to switch to reading original pages together with their respective interleaves sequentially on first exposure—assuming that this option is allowed viewers by the author of a document—he or she can summon the second version, again by pressing the appropriate targeted key. For example, by pressing the left-arrow key the viewer can return the document to the first page, or any other target page—whether an original page or an interleaf page, including pages beyond the last page viewed by a user at this point—according to the desires and direction of the author. Subsequent pressing of the right-arrow key will then advance the viewer through the second version of the document, yet this time interleaved pages or sections associated with the second version will also be viewable. These can include advertisements. The process is repeated and, at the option of the publisher, a third version and associated interleaves can be provided to the viewer. Prior to providing each version, payment authorization can be required of the viewer. This payment can be made at the time the next version is requested, such as by debiting a pre-paid account belonging to the viewer.

From an authoring standpoint, if the first string of the document is chose a by the author as the target, the left-arrow function can be programmed to reset the string counter to 1, thus returning the viewer to the first page, the utilization of other targets necessitating the resetting of the string counter to other numerals, of course. Additionally, the right-arrow function can be programmed to increment the string counter by an integer larger than 1 while the first version of the document is displayed, so that interleaved pages will be skipped.

### Alternative Embodiments

According to another aspect of the invention, two or more sets of string functions, for example, a PAAT set and a PIIT set, or one PAAT set and several PIIT(n) sets—where (n) is an integer greater than 1—will govern presentation of successive series of strings. This embodiment is useful for several reasons. For example, a writer might not want to be compelled to present exactly the same number of interleaves between each pair of pages, as he would be under certain embodiments described above. In addition, a writer using this approach can employ multiple different interleaf sets to present highly complicated and involved ideas or facts to a reader “serially” and progressively—at increasing levels of detail and sophistication, and/or refinement of ideas and argument—in consecutively presented sets of interleaves. And in addition, a writer may want to employ differing rules governing backward progression, such as one screen at a time, or all the way back to the beginning, in certain different, separate series of strings. Utilizing two or more different string headers corresponding to separate string functions will provide the additional flexibility in implementation.

The invention can be implemented through certain modifications being made to an existing Web browser, to an existing jump drive operating program, and to documents as described herein such that these documents will bear their own unique extensions, such as “.Nll,” in place of the current “.htm” or “.html” extensions. When these modifications are made, documents authored according to the invention are playable only from and storable only to designated pieces of digital memory equipment such as USB jump drives (memory stick, flash drive, thumb drive, etc.) or other hardware storage token, or in an alternate implementation, from and to the digital memory of particular computers and cell phones, for example. Likewise, when these innovations are implemented, various rigid and at this time-point unexpected and unusual restrictions can be placed upon viewers' used of electronic documents that they possess. And likewise, a fourth “fee delimiter” can be employed by authors, editors, publishers, and later commenters to assess fees of viewers “appropriately,” more or less proportionately to the viewer's use of the document.

A conventional jump drive has its own unmodifiable and unique serial number imbedded in it, just as every computer has a MAC address. This serial number in a jump drive can be considered the “container ID.” Assuming that a digital publisher issues unique jump drives for use according to this invention, which will hereinafter be referred to as “registered jump drives;” such drives are manufactured with, in addition to the regular container ID embedded on them, a stored special operating executable file to run the drive. This modified operating .exe file will include an “examine-alphanumeric-code before .Nll file can be opened” function written into it. The possessor of such a drive cannot open, play, or reveal the source code of a document with an .Nll extension, except when this .Nll file is stored on a jump drive known by the publisher to be a registered jump drive. This restriction is made possible particularly because of the special nature of the new web browser, which can itself exclusively open, play, and show source code of .Nll files—this browser hereinafter referred to as the B-prime, or “B′,” browser—in conjunction with other features of this invention.

A B′ browser can be used for security reasons, for example, in order to prevent a file with an .Nll extension from being opened and played and from having its source code revealed by any browser, other than a B′ browser, and except where this .Nll file was already stored on a registered jump drive. An existing browser can be modified in several ways, to become the B′ browser. For example, it can be modified to permit the embedding of a unique code module, which may be an alphanumeric expression, at a designated location within its code. Further, it can be modified to “handicap” certain expected functions of a web browser, such as the “open” and “show source code” of a markup language's file functions, so that these will not be executed unless certain preconditions are met. In addition, the browser can be modified to be able to check, at the request of the B′ browser itself, a continuously updated list (maintained by the publisher, for example in an online database) of registered jump drives that have been issued by the publisher, for the presence or absence of a particular container ID.

Thus, each .Nll file issued according to this method will be stored only on a registered jump drive—or alternatively, to devices of a different, yet comparable electronic storage medium type, including ones not yet marketed and/or ones utilizing technology not yet invented, including proprietary types—and will include in its file name a unique alphanumeric code issued by the publisher. A “check-alphanumeric-in-file name” function of the jump-drive operating program will determine if this filename code is valid. Then, assuming that the checked code is valid, a second function of the jump-drive operating program, a “check-alphanumeric-code-in-the-browser” function, will examine the code alphanumeric that is located in the B* browser program to determine if it is a valid B′ browser. Only if both preconditions are met will this .Nll then be opened by the B′ browser in a browser window.

When a file is opened in a B′ browser window, a handicapped “show source” function of this browser can reveal the source code of the .Nll file, but only if the browser has determined that a registered jump drive is present in one of the peripheral slots (such as D:, E:, F:, G:) of the electronic device running the browser. To prevent a viewer from disabling security and payment, features of .Nll documents, the content files and program files of .Nll documents can be made separable and the B′ browser's “show source” function handicapped so that only content files and not also program files will be revealed.

The operating program of a registered jump drive will not allow the electronic device running the B′ browser to store any document on this drive unless the file has an .Nll file extension, and it will not permit storing of any .Nll file, including any .Nll files that have been altered by a user, for example, to include his own “marginal notes;” except on a drive whereupon an .Nll file with the same name is already present, and then only by overwriting this existing .Nll file. To stress and emphasize, the storing of documents by a viewer on internal computer memory media, or on external electronic memory media other than the registered jump drives here discussed—yet excepting devices that are similar to jump drives, where the publisher deems these to be “more advantageous” from its vantage point than jump drives—will be blocked by the publisher according to the invention.

Copies of the B′ browser are each assigned an alphanumeric code at the time of their installation on an electronic device. Such copies of the browser will be made available to users, for example by free download from the publisher's website. This browser will be programmed in a computer language that can be compiled into an executable file. Because this code will be compiled, it will be difficult or impossible to fraudulently reverse engineer, including by the inclusion of a fraudulently created. browser alphanumeric code. Preferably, the algorithm used to generate alphanumeric codes, and concomitantly to determine whether alphanumeric codes that appear in .exe file names, .Nll file names, or individual copies of the B′ browser are “valid,” will be kept outside the public domain. Thus, efforts to fraudulently distribute electronic reading material in order to bypass the correct assessment of fees by a publisher will to an extent be frustrated.

According to this embodiment, individual copies of electronic books, pamphlets, articles, and other materials in electronic form will be available directly from the publisher's website after payment of a variable “maximum use fee” by each user. For example, a user wishing to obtain an electronic book or other materials will go to the publisher's website and log on there by providing his email address or other identifier and subsequently a payment method, for example, credit card account details. After log-on and provision of a payment method, users will be directed to separate web pages where a publication list is located. This list will indicate each item for sale, for example, at least by its title and maximum user fee. The maximum user fee will, be variable, from free to any fixed maximum amount, at the publisher's discretion.

When the user has identified an item that he wishes to procure, he will obtain it by selecting the item name, which will be a hyperlink, and then in a separate screen, by selecting a radio button to confirm his purchase, thereby paying the listed amount and receiving an email message having the selected item sent as an attachment This attachment will be written as an .exe file so that it will not exactly comprise the document representing the electronic book or other item. Therefore, it will not exclusively consist of the respective .Nll file that is to be played in a B′ browser after storage on a registered jump drive. Rather, the attachment will “embrace” the .Nll file, allowing it to be opened and the document contents immediately to be transferred to and stored on a registered jump drive, after certain preconditions have been determined to have been met. If out of security concerns, .exe files are not allowed to be opened directly from email attachments by, for example, antivirus software, corporate security policy implementations, or electronic-device operating platform measures, a storage step or other intermediate action will be performed.

Each published item purchased from a publisher's website will be assigned, at the moment of its creation by the publisher's website program, a suitable alphanumeric code that will be present in the file name of the .exe attachment. When the user opens this .exe from within his email program, it will be opened and immediately stored on the registered jump drive then in use as a novel .Nll document, upon certain conditions being met. For example, a registered jump drive must be found on or in direct communication with the device that is running the email program. Whether this drive is thusly present will be determined by the B′ browser that has been designated to open the .exe, for example by examining the peripheral slots of the electronic device running the browser, first for the presence of a registered jump drive, and second for whether there is a valid container ID number on that drive. Further, the attachment .exe file's alphanumeric code must be valid. Whether it is valid will be determined by the B′ browser. If both conditions are met, the operating .exe file of the registered jump drive will disarticulate the attachment .exe file to remove the respective .Nll file, and thereafter store only the .Nll under a file name that still will encompass the alphanumeric code, while also storing a copy of the original .exe on the registered jump drive.

When a viewer attempts to store a modified copy of any .Nll file, before it can be stored the operating software on the registered jump drive will compare the modified version to the original .exe itself, specifically in order to determine if any fee delimiters, either any ones in a string prior to, or alternatively “forward of the last-read string;” have been removed during editing of the new .Nll version—the version that the viewer now hopes to store. This will be done so that correct payment for use of the .Nll cannot through such means be avoided by a viewer. Only if no relevant fee delimiters have been removed can storage of the new .Nll version occur, replacing the old version.

Multiple .exe attachments maybe disarticulated, reconstituted, and stored on a single registered jump drive, making it in effect a “library” for all of those .Nll documents. Preferably, at the time of purchase, all .Nll documents will exist in a single copy. If a user chooses to place multiple .Nll materials on a single drive, he will be unable to loan these out singly, as individual items. Regardless of whether he stores many .Nll materials on the same drive or only on multiple drives, he will have but one copy of each one, whether this copy is annotated or clean, to keep or to loan out, unless he opts to purchase multiple copies of any .Nll.

The operating executable file of the registered jump drive will allow an .Nll file to be erased from one drive while simultaneously being stored to a second drive that is present in another auxiliary slot, so as to allow files in a library that is present on a single drive to be loaned out while the overall library is retained, and to allow these loaned files to be returned in a similar manner. Alternative embodiments implement use of an associated log file to facilitate and record such transactions. Any such log file can be used to determine loan duration for purposes of, for example, billing.

If a publisher wishes to charge users to read .Nll items, he will have a novel means by which he may do so according to an embodiment of the method of this invention. Through use of a fourth delimiter type mentioned above, the publisher will be able to charge a varying amount, front no fee up to an indefinitely large fee, each time the user passes such a delimiter (under certain circumstances, a user will be paid to read an .Nll item, in which case negative fee amounts will be incurred). The publisher who utilizes such an approach will store on the registered jump drives he makes available a second .exe file, or other compiled program. This .exe file's function will be to maintain an account for the user with respect to this publisher. When a user acquires .Nll items, their maximum use fee will be stored into individual variables in this account .exe file on the registered drive. When a user reads one of these items, as he passes a fourth delimiter, the amount in the .Nll item's amount variable will be decremented according to the fourth delimiter in question, where accounts are pre-paid. Of course, other payment schemes, such as credit models, may be used, in which case the amount variable can be incremented.

In a case in which a computer program devised according to the method of this invention does not permit delimiters such as the fee delimiter to be meaningfully interpreted by the CPU except where they are encountered through the viewer's pressing the ahead-a-page-at-time action key, in our example the right-arrow key, the author can code for a “redirect key” or “redirect keys” similar to the left-arrow key previously discussed, by modifying the program file of the .Nll document. Such a redirect key when pressed will direct a reader to the first string of a section of the text file that is beyond all of the portions he has read so far, and possibly beyond the end of the initial document. There, a second presentation of the same section that the reader has just finished will be presented, similar or identical to it in all ways excepting that between the “initial pages” of the section, interleaves with delimiters have been inserted by the author.

When this approach is used, a method can be employed to return the reader to the point from which he departed, preferably through the reader's pressing a designated “return key” once the end of a jump section has been reached. This method may also be automatic. So that no interleaf strings will be skipped as this section of document file is viewed by the reader, all of its strings can bear a unique string label, for example PIIT(n), where (n) is a variable integer. Simultaneously, the portions of the program file governing presentation of strings bearing this label will dictate that the string counter advance by 1 when the end of a string in the section is reached.

Assuming that a user chooses to stop reading before finishing an .Nll file, he will be able to close and re-open this file, and to read up to this point as often as he likes, without incurring further fees. If he chooses to read beyond that point, however, he will incur further fees, and the amount variable for this .Nll file will be decremented according to the method of this invention.

If a user affirmatively decides that he will not read further in this .Nll file, he can communicate this to the publisher or the publisher's agent in a manner that was previously designated as a mode to obtain a refund or credit. For example, he can send a “refund email” to a designated email address maintained by the publisher, sending this from the account from which he had purchased the corresponding .Nll file. He will attach to this email a file that will have automatically been created using an executable file that is present on all registered drives. This executable file, when invoked, will create a transaction file having as its file name the complete name, including alphanumeric code, of the unfinished .Nll file, and including in encrypted format the name of the respective amount variable, the alphanumeric code representing the respective registered jump drive, and the number that is in this amount variable at the time of this file's creation by the executable file.

In an alternative implementation intended to prevent a fraudulent refund request from being mistakenly granted by the publisher, in the refund email the current .Nll copy will be automatically included as an attachment Then when the refund request is received by the publisher, this version will be compared against the original executable corresponding to it, which will be retained on the publisher's server, to ensure that the .Nll copy is intact and uncorrupted, and particularly that fee delimiters have not been removed.

At the time of the transaction file's creation, the respective amount variable on the registered jump drive will be re-set to zero. When such a “refund email” correctly bearing all requisite attachments is received by the publisher—for example, if a viewers version of the .Nll file is attached, and this is subsequently found by the publisher to be intact—the user's account, such as his credit card account or a deposit account, will be credited the amount remaining in the amount variable (possibly reduced by a predetermined transaction amount)—where the checking of the attached .Nll file and the determination of whether a refund is appropriate can be carried out by an automatic “server-side” program that will be maintained by the publisher, or by the publisher manually, or by it automatically with the possibility of manual override. Subsequently, the user may open, read, and modify his own copy of this .Nll file as often as he likes, yet may not go beyond the point at which he stopped without logging back onto the publisher's website and increasing the amount variable for this file, to cover the maximum fee he might pay while reading the remainder of the file.

Similarly, if a reader has been able to complete an .Nll file without the amount variable tor this file having been brought to zero—perhaps because he or she carefully and intelligently answered questions that were posed by the author as a pre-condition for reading more of the .Nll file—this reader can also send to the publisher such a “refund email” to obtain a partial refund of the maximum fee for the .Nll file. Any other type of reward offered by the publisher for correctly answering questions can be redeemed in a similar manner.

The amount variable may be decremented precisely by the amount dictated by that fourth delimiter, or it may be decremented by an amount equaling the delimiter amount multiplied by a real or particularly a rational number that will be the current score multiplier. In .Nll materials published under this approach, the value of the current score multiplier, after initially being set to a value of 1, will vary according to a formula at the publisher's discretion, for example, as dictated by the user's scores on questions that he will intermittently be required to answer while reading this .Nll document, before being permitted to proceed.

As indicated elsewhere, such questions are preferably directed to material that a user should know based on what has already been presented in the .Nll document. Alternatively, the questions can be directed to information that has not been discussed, yet which someone who is qualified by reason of training to read this particular item should know or should infer from the previously-read material. Still alternatively, the questions can be irrelevant both to the material covered in the .Nll document and to the relevant topic field. In this case, for example, questions might be posed merely to slow a user's progress, and for no other reason, or they might be posed as a method of appropriately allocating cost, inasmuch as readers with more wealth or more indifference to spending on an .Nll item may more gladly answer questions indifferently simply to be able to continue reading, while others with less wealth or more available time will scrupulously answer the questions, to keep their costs low. Alternatively, if an author wishes to slow allocation of installments of a newly published .Nll item—perhaps to mimic Dickens's “serialization” approach, or otherwise to draw out the time that a reader will have to contemplate and draw connections among information he had been exposed to—all of the questions might be physically or otherwise impossible to answer until a certain day. For example, the question might be related to a particular event that has yet to occur, but will occur with certainty and with a particular, discrete, “digital-format” result at a particular future time—similar to an honest version of the old “Harlem numbers racket approach.”

According to a basic implementation of the present invention, one which does not involve the use of interleaves, which will permit forward and backward movement through a modified document one page at a time only, it is possible for a final edited version of a manuscript to be presented, and for the writer's final draft also to be presented beside it; so comparisons between the two by interested readers may be made. Preferably, the two documents will be coded within a single string in three distinct, yet ultimately geometrically overlapping CSS div elements, the second and third of which will be separated from the first and second of which by means of a delay delimiter or a stop delimiter.

Without a delay delimiter or a stop delimiter being emplaced between divs in a string, the transition from one div to the next in programs created according to the invention, can occur almost instantaneously. This feature of such programs allows “CSS formatting shifts” and especially the automatic addition or deletion of annotation material such as annotation boxes to occur many times faster within a line than it does as the CPU reading frame moves from one string to the next automatically, absent a delimiter, while non-interleaf .Nll material is being displayed.

In thusly formatted edited materials, the second div element will always be formatted to overlap and conceal the first div element, and the third to overlap and conceal the second. The first CSS div element will include the authors final draft, while 5 the second will constitute a two-color, or otherwise marked-up final edited version, and the third, an identically formatted monochromatic “clean,” or that is to say, un-marked-up version. In an alternative implementation, two or three successive strings may be used instead of one string. In the two-color edited version, all additions by the editorial team can be shown in a different text color from that of the unchanged material, while all emendations from the author's final draft can be indicated and pointed to, for example through placement of an HTML tag, such as the “&curren;” tag, that may or may not be of the same color as the background color in either the former or particularly the latter edited version, at the point of the elimination of the original textual material. Where such a tag is displayed in the identical color as the background color, such a tag will not “show” unless the entire document is highlighted, or otherwise the pertinent passage is highlighted by the reader. Alternatively, the color of the tag can be similar to the background color, in which case the tag will appear but not stand out, unless that section or the whole page is highlighted by the reader.

An alternative approach, which will be effective in showing not only where text was removed but also which text was removed, is for an editor, or an author, to convert ordinary black text that is displayed against a white background, to white text against a gray background in the edited version. Where this has been done. If an interested viewer wishes to, he or she can reveal the “missing,” in the sense of edited-away, text by highlighting the screen or sections of text. The same approach—that is, hiding material, yet hiding it in an open way in the expectation that some readers (whether particularly prompted to go searching for it or not, by the author) will find it—can be employed by authors in other contexts for heuristic or other reasons, including “perverse” in the sense of immature ones. Taking advantage of the fact that readers of documents created under this invention may more routinely than now open the source file of Web pages, authors can in a similar way and for like reasons—perhaps in conjunction with the foregoing approach—hide new information or comments in some strings as “non-displayed material,” such as between angle brackets.

Other schemes for marking up edited text can be used, within the spirit and scope of the invention, as will be apparent to those of skill in the art.

According to an alternative formatting scheme for presentation of text differently between original pages and the corresponding interleaf pages, an original, set of pages is presented to a user according to the method of the invention, these consisting of a long series of paragraphs that are individually or in groups, presented in like-formatted boxes having a background color that is other than the color of the text. Next, a corresponding set of interleaf pages can be presented to the user according to the method of the invention, these offering both the identical original material, with or without typographic or textual modifications, and between certain of those paragraphs, intercalated commenting or explaining paragraphs can be emplaced on the interleaf page, which will be similarly but not identically formatted to the long series of original paragraphs above and below them. Where secondary material is presented in an interleaf the original material can be unchanged, or it can be modestly changed in terms of certain formatting features such as the color or holding of text to draw attention to individual words or thoughts. Likewise, in interleaves, even though the bulk of the text will be presented vertically in a series of paragraphs, this long rank of paragraphs can be accompanied by new material that will appear beside or partially overlapping the series of paragraphs in annotation boxes, as discussed elsewhere herein.

Particular embodiments include means by which any reader can usefully annotate his or her own copy of an .Nll document and file it in the sense of publish it as an “original document plus addenda” version through the publisher's website. Accordingly, for every “original document plus addenda” version that is sold, the original fee will still be paid automatically to the publisher, and in addition, some other amount—a multiple of the original fee amount equal to, greater than, or less than the original fee amount that would ordinarily be paid by a reader to the publisher of the original document for that document—can be paid as an “accessory” fee to the commenter.

Preferably, commenters will have an expert background or only sound insight according to some objective criteria, although neither of these will be necessary, unless, for example, so dictated by a publisher who opts to “pre-screen” comments to approve or disapprove of their addition to an existing document. A number of commenters can contribute in succession, all of whom will be paid what they originally would have been paid, each time the original document is sold with their respective comments added on. It is contemplated that commenters can take a good .Nll document and improve it, and also that they can take originals that have less value and make them more saleable.

Thus, the amount that authors and commenters can earn from their work will depend not only on the quality of their work, but also on factors that will initially be indeterminate, such as demand, perhaps after multiple rounds of commenting. Publishers, therefore, will be able to establish a protocol by which the price of the original work and prices of additional components can be modified later. These price modifications can be made by the publisher at will, and/or by the publisher, author, or subsequent commenters, by individual agreement or, for example, according to an algorithm, or as otherwise set up according to the publisher's preference.

.Nll documents can be published in which, prior to every page seen by readers on a normal first read-through of the document, there will be an interleaf that will be identical to the normally seen page; so this identical interleaf page can be accessed by a reader from the normally seen page through pressing a back-one-page-at-a-time key from the normally seen page, one time. Alternately and equivalently, such identical interleaf pages can be present after every normally seen page, so each identical interleaf can be accessed through the reader's pressing a forward-one-page-at-a-time key; one time. As well, such identical interleaf pages can be placed before and after each normally seen page.

Where an identical interleaf was inserted by an author before, or after, each normally seen page, readers taking notes can easily retain a clean and unmarked “reference version” of every page even where they wanted to “edit” or take notes on the normally seen pages.

To generate such documents, an author makes simple changes to the program file of the .Nll document in order to increment the number of interleaves that will be automatically skipped each time the advance key was pressed by one, while simultaneously duplicating each string and placing it appropriately in the text file, immediately before or after, or both, all of the normally seen pages. Readers can, as has been indicated elsewhere in this application, make notes on or more extensively edit pages they were reading through opening the source code of the document and then modifying the string representing that page in a text editing program—here doing this either with the string coding for the normally seen page or with the string coding for the corresponding interleaf—before saving the revised document under its original .Nll document name on the same registered jump drive where it bad originally been stored.

Such interleaf pages at the reader's discretion might be kept “forever clean” for ease of reference, or they might be kept clean only temporarily, for example in order that the reader might be able to return to the .Nll document later in order to record new skeins of thought such as might occur to him on reflection after the passage of time, or such as could occur through a second reading. In an alternate implementation, such identical interleaf pages might be retained temporarily unmarked in order that some second commenter, or various commenters', ideas can be recorded in the same document, in addition to the original commenter.

The author can make the number of interleaves that will be present between every pair of normally seen pages vary from none or one, to any arbitrarily large number—this accomplished through the author's making simple changes to the document's program file while also appropriately duplicating every string representing each normally seen page the desired number of times, and placing the correct number of identical string copies suitably before or alter, or both, every normally seen page. When reading such an .Nll document after modification, any reader—whether the original reader or another reader—will be able to access all of the here-discussed edited pages by pressing the back-one-page-at-a-time key (or the forward-a-page-at-a-time key, as appropriate) a suitable number of times.

If at any point in the text file, the author wishes to increase the number of “clean pages” that are intercalated between normally seen pages, so they will available for modification by readers, this can be accomplished by inserting one or more complete duplicate sets of original pages, plus interleaves, at that point. Only one of the original pages can contain one or more pause delimiters and must contain at least one stop delimiter. In the case of that set of interleaves which precedes (or follows) this “stopped” page, certain of the interleaves must be other than blank, if the author wishes to make any comments on and upon that original page in its interleaves.

Where one or more identical original pages precede a “single articulated original page”—the original page containing at least one stop delimiter and/or pause delimiters—the viewer will never see the duplicate pages as these pass by. The viewer will instead see as always, only a page stop.

Where the duplicated non-stopped page or pages follow the “stopped” original page, the viewer if noticing the duplicated original pages at all, will notice them merely in the sense that the “interpage transition” to the first original page alter the stopped original page will seem marginally slower than usual, after the viewer strikes the action key to resume presentation.

If the reader and not the author is the one who wishes to expand opportunities for comment, the identical approach may be used. The reader can do so without needing to open the program file in order to modify the line-skip number pertaining to these strings. (Technically, according to the invention this is a counter-factual. And even could it be done, still there would be the unfortunate side-effect that the number of interleaves per interleaf set would have to be increased constantly everywhere in the document—including around original pages that were of no interest or the value to the reader.)

Where an author might wish to allow individuals who had read up to a certain point in an “index document”—however, only those readers and no others—to access a presumably related “secondary” .Nll document, he can achieve this limitation through placing a hyperlink at a desired point in the index document, which when the hyperlink is activated will automatically open a form, allowing transmission of an email containing the respective coded .exe attachment to the reader's email account—much as discussed elsewhere in this application. Under this method, such .exe attachments can never be decoded other than by a B′ browser as elsewhere described, and moreover they can neither be decoded nor stored except when the same registered jump drive on which the index document which was in the process of being read had been stored, was simultaneously present in an accessory drive on this same computer.

In an alternative implementation of the invention, an author, an editor, or a later commenter can record on paper his pertinent thoughts and ideas, insights, criticisms, qualifications, elaborations, further details, and further explanations that had not been presented in the “main-page” material itself and which it was felt readers might want know after reading the respective main-page material.

Such notes are scanned as images in order to be placed as an “img” file at an appropriate point, such as through the Cascading Style Sheets formatting feature of HTML. Preferably, notes are set off from the text of the main-page, for example through use of paper of a different color than had been used in the main-page. Annotated pages can be inserted directly after or directly before the respective main page, as interleaves, for example.

Alternatively, notes, instead of being included in a document as interleaves, can be included in the same string that was coded for the respective main-page, for example at the end of it, after a stop code.

If material presented in a note is not easily readable or is not routinely intelligible—by design of its author—a “translation” of this can be offered to interested readers in a separate interleaf after the payment of an additional fee or otherwise.

Notes can be recorded in cursive, printing, or block letters, and they can be by intent, legible, less legible, or completely illegible. Notes also can be presented in the form of sketches, diagrams, graphs, formulas, equations, and the like. Any verbal or non-verbal type of note can be used.

Notes can be presented in shorthand. When shorthand is used, the shorthand system that is used can be a conventional system of shorthand, or it can be a non-conventional and obscure system, which is not easily readable by the uninitiated. Also, note material can be typed.

Notes can be augmented with further handwritten amendments, emendations, or corrections, or other editing—where such can be made by the author of the note himself or by an editor or a later commenter.

Particular exemplary embodiments of the present invention have been described in detail. These exemplary embodiments are illustrative of the inventive concept recited in the appended claims, and are not limiting of the scope or spirit of the invention as contemplated by the inventor.

I claim:

1. A method of governing content presentation, comprising:
creating a document file, wherein the document file is a variable computer-readable file that includes content, wherein the content is presented to a user in discrete units in sequence on an electronic display device;
presenting a current version of the content, in which fewer than all of the units of the content are viewable by the user, wherein at least some units of unviewable content are interspersed between units of viewable content;
performing, by the user, a predetermined action; and
in response to performance of the predetermined action, presenting a subsequent version of the content, such that at least some of the unviewable units of content in the current version of the content are viewable in the subsequent version of the content.

2. The method of claim 1, further comprising redirecting presentation of the content to a different unit of content when the predetermined action or another predetermined action is performed by the user.

3. The method of claim 2, wherein redirecting presentation of the content to a different unit of content includes returning presentation of the content to a previous unit of the content.

4. The method of claim 2, wherein the different unit of content is a unit of content that was unviewable in the current version.

5. The method of claim 1, wherein the subsequent version of the content is not presented on performance of the predetermined action unless a predetermined number of units of content has been viewed by the user prior to performance of the predetermined action.

6. The method of claim 1, further comprising associating a monetary charge with a performance of the predetermined action.

7. The method of claim 6, further comprising increasing a total monetary charge each time the predetermined action is performed.

8. The method of claim 7, further comprising notifying the user each time the total monetary charge is increased.

9. The method of claim 7, further comprising providing indicia to the user showing the total monetary charge.

10. The method of claim 1, wherein the predetermined action is movement of an action key, wherein the action key is an element of an input device in communication with a microprocessor device that is in communication with the electronic display device.

11. The method of claim 1, wherein at least some of the unviewable content is textual content.

12. The method of claim 11, wherein the unviewable content includes annotation content.

13. The method of claim 1, wherein the electronic display device defines a size of a unit of content.

14. The method of claim 1, wherein the electronic display device is a dedicated content reader.

15. The method of claim 1, wherein creating a document file does not include writing programming code.

16. The method of claim 1, wherein the content farther includes at least one data tag.

17. The method of claim 16, wherein the at least one object tag includes at least one of formatting tags, hyperlink tags, image source tags, sound source tags, video source tags, table tags, form tags, frame tags, style tags, div tags, class tags, embed tags, object elements, JavaScript, and Java applets.

18. The method of claim 1, wherein presenting the content includes reading the document file using a network interface.

19. The method of claim 1, wherein the network interface is a Web browser.

20. The method of claim 1, wherein the document file is one of a plaintext file, an HTML file, and an XHTML file.

21. The method of claim 20, wherein the unviewable content includes advertising content.

22. The method of claim 1, wherein the document file incorporates Javascript.

23. The method of claim 1, wherein the predetermined action is providing a correct response to a query.

24. The method of claim 1, wherein the document file includes at least a textual portion, the method further comprising:
inserting at least one delimiter at a selected position of the textual portion of the document file, defining delimited content; and
tracking predetermined events and/or actions that occur while the user views units of content.

25. The method of claim 24, wherein the selected position is occupied by a particular character combination including the at least one delimiter.

26. The method of claim 24, wherein the at least one of:
stopping advancement of content until further action is taken by the user;
pausing presentation of content for a selectable, discrete number of time units; and
automatically redirecting presentation of the document file to a different location in the document file
occurs when the at least one delimiter is reached as the user views units of content.

27. The method of claim 24, wherein tracking predetermined events and/or actions that occur while the user views units of content includes tracking a number of the delimiters passed by the user while viewing units of content, and/or tracking a number of units of content passed by the user while viewing.

28. The method of claim 27, further comprising associating a monetary charge with the tracked number of delimiters passed by the user and/or the tracked number of units of content passed by the user while viewing.

29. The method of claim 27, wherein the delimiters are present in the viewable units of content of the current version of the content.

30. The method of claim 25, further comprising increasing a total monetary charge each time a delimiter is passed by the user and/or each time the number of units of content is passed while viewing.

31. The method of claim 30, further comprising notifying the user each time the total monetary charge is increased.

32. The method of claim 30, further comprising providing an indication to the user showing the total monetary charge.

33. The method of claim 27, wherein the unit of content is a string.

34. The method of claim 1, further comprising modifying at least one of a browser, a jump drive operating system, and the document file, wherein the modification to the document file includes a designated extension.

35. The method of claim 34, wherein the modifications conjointly render the modified document file unable to be modified.

36. The method of claim 34, wherein the designated extension renders the modified document file unable to be stored except on the modified jump drive.

37. The method of claim 34, further comprising:
storing a container ID and an operating executable file on a jump drive associated with the modified jump drive operating system:
assigning a filename to the modified document file, wherein the filename includes a designated filename code;
assigning a designated browser code to the modified browser;
storing the modified document file on the jump drive;
using an operating program associated with the operating executable file to determine if the filename code is valid, based on a predetermined criterion;
using the operating program associated with the operating executable file to determine if the browser code is valid, based on a predetermined criterion;
opening the modified document file in a browser window by the modified browser only if the filename code and the browser code are both determined to be valid; and
refraining from opening the modified document file if one or both of the filename code and the browser code is determined not to be valid.

38. The method of claim 37, further comprising:
registering the container ID with a publisher; and
preventing storage of the modified document file on any jump drive having an unregistered container ID.

39. A method of governing content presentation, comprising:
creating a document file, wherein the document file is a variable computer-readable file that includes content, wherein the content is presented to a user in discrete units in sequence on a display device;
presenting a current version of the content, in which fewer than all of the units of the contents are viewable by the user, wherein at least some units of unviewable content are interspersed between units of viewable content;
inserting at least one delimiter at a selected position of the document file;
viewing units of content sequentially by the user,
in response to passing the selected position by the user while viewing content,
presenting a subsequent version of the content, such that at least some of the unviewable units of content in the current version of the content are viewable in the subsequent version of the content.

40. An integrated device comprising a storage medium, a microprocessor device, and an electronic display device;
wherein the storage medium comprises intransient instructions in a variable computer-readable document file that can be implemented by the microprocessor device to cause a document to be displayed to a user on the electronic display device according to instructions included in a program file,
wherein the instructions in the document file include:
allowing an author to create variable computer-readable content as a portion of the document file, wherein the content is presentable on the electronic display device in sequential, discrete units;
presenting on the electronic display device a current version of the content in which fewer than all of the units of the contents are viewable by the user, wherein at least some units of unviewable content are interspersed between units of viewable content;
recognizing when a predetermined action is performed by the user; and
in response to recognition of performance of the predetermined action, presenting a subsequent version of the content, such that at least some of the unviewable units of content in the current version of the content are viewable in the subsequent version of the content; and
wherein the instructions included in the program file are a computer-readable instructions that are largely unvarying and include previously programmed computer code allowing the document file to be executed.
